(19) United States
(12) Patent Application Publication
(10) Pub. No.: US 2026/0340142 A1
(43) Pub. Date: Oct. 29, 2026

(54) METHODS AND APPARATUS FOR SECURE ISOLATION OF APPLICATIONS

(71) Applicant: Infineon Technologies AG, Neubiberg (DE)

(72) Inventors: Abhijit Ambekar, Munich (DE); Tobias Islinger, Höhenkirchen-Siegertsbrunn (DE); Laurent Heidt, Sauerlach (DE)

(21) Appl. No.: 19/192,439

(22) Filed: Apr. 29, 2025

(51) Int. Cl. G06F 21/57; G06F 11/07

(52) U.S. Cl. CPC G06F 21/577; G06F 11/0793; G06F 2221/2141

(57) ABSTRACT

Systems, methods, and circuitries, are provided to allow enforcement of an isolation scheme even in low power mode by implementing the enforcement aspect of the isolation scheme in a secured isolation circuitry that belongs to a lower power mode than a root of trust circuitry that implements the configuration aspect of the isolation scheme. In one example, secured isolation circuitry includes a memory configured to store secured access configuration information and a processor. The processor is configured to verify a target access configuration associated with a transaction target based on the secured access configuration information and, in response to failed verification, perform one or more remediation operations.

### FIELD

The present disclosure relates generally to the field of processors and central processing units (CPUs) and more particularly to an access control system for a processing system that includes one or more initiators that share access to target resources.

### BACKGROUND

Modern microcontroller units (MCUs) include system on chip (SoC) architectures in which an interconnect structure controls access to shared resources by one or more initiators such as central processing units (CPUs), processing cores, virtual machines, and so on. Isolation between the initiators' access to shared resources is an important feature of such architectures

### BRIEF DESCRIPTION OF THE DRAWINGS

Some examples of circuits, apparatuses and/or methods will be described in the following by way of example only. In this context, reference will be made to the accompanying Figures.

FIG. 1A is a diagram illustrating an example hierarchy of power domains in an MCU, in accordance with various aspects described.

FIG. 1B is a block diagram of an example MCU architecture that includes root of trust circuitry, in accordance with various aspects described.

FIG. 2 is a block diagram of an example MCU architecture that utilizes transaction identifiers (TIDs) to enforce isolation between transaction initiators, in accordance with various aspects described.

FIG. 3 is a block diagram of an example MCU architecture that includes secured isolation circuitry that verifies a target access configuration, in accordance with various aspects described.

FIG. 4 is a functional block diagram illustrating an example secured isolation circuitry, in accordance with various aspects described.

FIG. 5 is a functional block diagram illustrating an example secured isolation circuitry, in accordance with various aspects described.

FIG. 6 is a flow diagram outlining an example method that may be performed by secured isolation circuitry, in accordance with various aspects described.

FIG. 7 is a flow diagram outlining an example method that may be performed by root of trust circuitry, in accordance with various aspects described.

### DETAILED DESCRIPTION

The present disclosure is described with reference to the attached figures. Similar components in various figures may be represented by similar reference characters. The figures are not drawn to scale and they are provided merely to illustrate the disclosure. Several aspects of the disclosure are described below with reference to example applications for illustration. Numerous specific details, relationships, and methods are set forth to provide an understanding of the disclosure. The present disclosure is not limited by the illustrated ordering of acts or events, as some acts may occur in different orders and/or concurrently with other acts or events. Furthermore, not all illustrated acts or events are required to implement a methodology in accordance with the selected present disclosure.

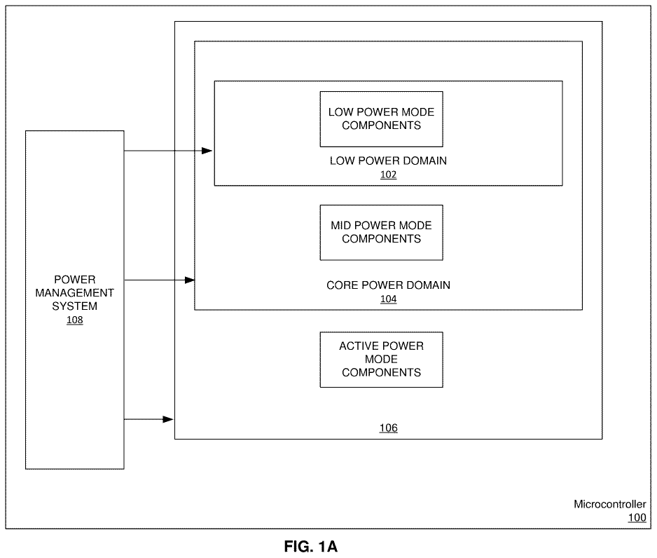

FIG. 1A is a block diagram illustrating the concept of different power domains or modes in a microcontroller 100. In the illustrated example, the microcontroller includes a low power domain 102, a mid power domain 104, and an active power domain 106. A power management system 108 selectively activates the different power domains based on many different factors including the present operating condition of the microcontroller, a number or type of operations the microcontroller is being called on to perform, whether power conservation is to be prioritized, and so on. Each power domain includes a set of microcontroller components, such as central processing units (CPUs) or cores, memory, peripheral devices, and so on that are energized and placed into an active mode when the microcontroller is operating in the corresponding power mode.

For example, to cause the microcontroller 100 to operate in low power mode, the power management system 108 causes power to be provided to low power mode components associated with the low power domain 102. To cause the microprocessor to operate in mid power mode, the power management system 108 causes power to be provided to low power mode components associated with the low power domain 102 and to mid power mode components associated with the mid power domain 104. To cause the microprocessor to operate in active power mode, the power management system 108 causes power to be provided to low power mode components associated with the low power domain 102, to mid power mode components associated with the mid power domain 104, and to active power mode components associated with the active power domain 106.

Thus, the power domain structure may be conceptualized as a hierarchy where the active power domain is the highest power domain or mode in which the most or all microcontroller components are powered up and active while the low power domain is the lowest power domain or mode in which the fewest microcontroller components are powered up and active. In other words, the mid power domain is a lower power domain than the active power domain but a higher power domain than the low power domain, and so on. It is noted that the terms low power domain, mid power domain, and active power domain are used in a general sense and indicate generally hierarchical power domains. Depending on the microcontroller, these power domains or modes may be called sleep, idle, standby, active, run, low, and so on.

Multicore microcontrollers may execute multiple independent software applications simultaneously and often software isolation between the applications is desirable. The access protection mechanisms used by a microcontroller may be required to meet Automotive Safety Integrity Level D (ASILD) for applications with ASILD targets and security requirements for applications with security targets. Multiple applications with different safety and security targets, (e.g., ASILD, Security, QM, and so on) may be referred to herein as applications with mixed criticality.

Each application in execution on a microcontroller uses a subset of the microcontroller's on-chip resources such as a CPU (e.g., core, virtual machine) for software execution, memory, direct memory access (DMA), and so on. Different applications may have different requirements regarding the allocation of on-chip resources as between applications as well as the allocation of on-chip resources to different sub-tasks associated with each individual application. Amidst the sharing of hardware resources, it is desirable or even required that different applications be isolated from one another. In some instances, different tasks or functions of the same application should be isolated from one another. In a general sense, isolation between two application tasks or functions means that each of the application tasks may be assigned its own individual access privilege level to shared resources (also called targets or transaction targets herein). The access privilege level may be, for example, a level of read and/or write access to a certain portion or function of a target module. In this manner shared resources designated for use by a certain application task may be protected from access by unauthorized application tasks.

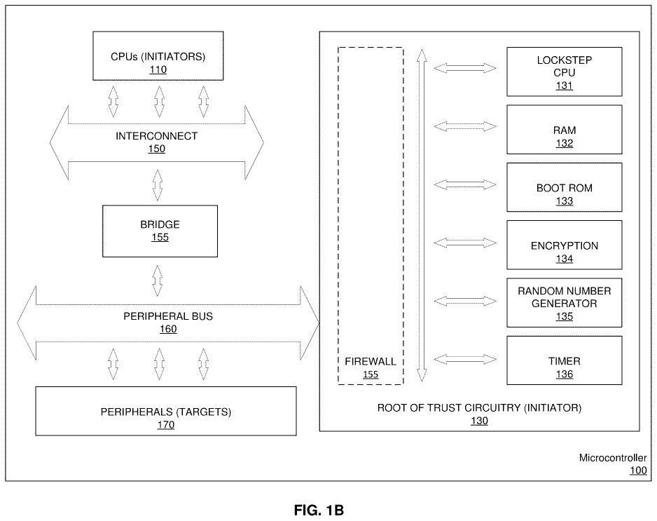

FIG. 1B is a block diagram of a microcontroller 100 that includes multiple CPUs or cores 110 that share access to peripherals 170 by way of an interconnect system that, in the illustrated example, includes an interconnect 150, a bridge 155, and a peripheral bus. As will be described in more detail in FIG. 2, the CPUs 110 may be characterized as transaction initiators while the peripherals 170 may be characterized as targets of the transactions. The CPUs 110 communicate with memory and other resources (not shown) by way of the interconnect 150. The interconnect 150 is coupled to the peripheral bus 160 by way of the bridge 155. A root of trust circuitry 130 is a special initiator that is separated from the other transaction initiators by the bridge 155 (shown also as a firewall 155 within the root of trust circuitry). The root of trust circuitry 130 operates in a separate protection domain and provides a secure computing platform or “root of trust”. The root of trust circuitry 130 provides secure key storage, cryptographic operations, and other secure boot related operations for the microcontroller. In other words, the root of trust circuitry is the service provider for cryptographic operations requested by any application in execution by the microcontroller.

The illustrated root of trust circuitry 130 includes a dedicated CPU 131 which may include a lockstep core, random access memory (RAM) 132, boot read only memory (ROM) 133, encryption circuitry 134, a random number generator 135, and timer circuitry 136. The CPU 131 is configured to execute secure boot instructions stored in the boot ROM 133 upon microcontroller power ON or reset. The encryption circuitry 134 is specialized hardware that is adapted to perform high speed encryption and decryption operations. The encryption/decryption operations may be based on keys stored in the RAM 132 or boot ROM 133 or other protected memory within the root of trust circuitry 130 or external memory accessible only by the root of trust circuitry 130. The encryption circuitry 134 may generate keys based on random numbers generated by the random number generator 135 or other kernel stored in the RAM 132 or boot ROM 133 or other protected memory within the root of trust circuitry 130 or external memory accessible only by the root of trust circuitry 130.

The root of trust circuitry is a general term for an isolated or protected hardware component that supports security-related operations for the microcontroller. Depending on the microcontroller, the root of trust circuitry may be referred to by many different terms, including hardware security module and so on. As discussed with reference to FIG. 1A, different initiators and targets may be assigned to different power domains. For example, a certain CPU of the CPUs 110 may be assigned to a lowest power domain and be configured to maintain minimal microcontroller functionality (e.g., the ability to monitor for certain triggers and transition to a higher power mode in response to the triggers). Other initiators and targets will be assigned to the higher power domains. For example, due to its fairly significant power consumption, root of trust circuitry 130 may not be assigned to the lowest power domain.

To provide isolation between applications, transaction identifiers (TIDs) may be included with transactions that are provided by an initiator 110 to the interconnect 150 and seek access to a target 170. Each TID is mapped a specific application or function in execution on a particular CPU. The TIDs are mapped, at the targets, to specific types of access such as read only access or read and write access.

FIG. 2 is a block diagram of an example microcontroller 200 that uses a TID-based approach to providing isolation between applications. The microcontroller 200 includes three transaction initiators 210, three transaction targets 270, and an interconnect 250 that controls the routing of transactions from the initiators to the targets. Example initiators include a CPU, an Ethernet controller, a system direct media access (DMA) controller, a CAN XL module, a peripheral component interconnect express (PCIe) module, an xGETH DMA module, a gigabyte Ethernet (GETH) DMA, and so on. Transaction targets (e.g., peripherals) 270 are associated with shared resources or services. Example transaction targets include component object model (COM) interface control registers, a static random access memory (SRAM), system target functions with control registers, and so on.

Each initiator includes several sub-modules that may be assigned to different applications. For example a CPU may have sub-modules (e.g., groups of hardware components) that correspond to different privilege modes, virtual machines, operating systems, and so on, each of which may be assigned to support different applications/application sub-tasks. Within a transaction, different functions of a transaction initiator 210 may be uniquely identified by certain address-phase attribute values (e.g., a virtual machine (VM) ID, application specific ID (ASID), machine privilege level (M), supervisor privilege level (S), user privilege level (U), and so on). The transaction also includes an opcode that identifies a particular access request (e.g., read or write) to a particular transaction target 270.

To implement an isolation scheme between the various applications in execution in the microprocessor, an access control mechanism is created in which different TIDs are assigned to the applications and functions that require isolation from one another. The access control mechanism includes three phases: configuration, execution, and enforcement. The root of trust circuitry 230 may execute boot instructions that define isolation requirements as between applications and/or interact with transaction initiators during a start up process to generate a root of trust access configuration 285 for each transaction initiator. In the initiator access configurations 225 TIDs are mapped to respective applications and/or functions. In the target access configurations 265 TIDs are mapped to respective types of access to transaction targets. The initiator access configurations 225 and target access configurations 265 are provided to (e.g., transmitted to or otherwise made accessible to) initiators 210 and targets 270, respectively, by the access control configuration circuitry 280.

The initiator access configuration 225 is used by access control execution circuitry 220 to select a TID for appending to a transaction based on the application or function that generated the transaction. Respective access control execution circuitries 220 may be associated with respective initiators or groups of initiators 210 and implemented within the initiator 210, within the interconnect 250, or in components external to both the initiator 210 and the interconnect 250.

In one example, the initiator access configuration 225 includes a TID assignment register (TAR) set, with each register mapping a TID to one or more specific application sub-tasks associated with the particular combination of address phase attribute values. Based on the TAR register content and the address phase attribute values, the access control execution circuitry 220 appends a TID to each transaction generated by the initiator 210.

The access control configuration circuitry 280 provides a target access configuration 265 for each transaction target. The target access configuration maps TIDs to types of access to the transaction target (e.g., read, read/write, neither read nor write). Different TIDs that are mapped to the same read/write access may be used in order to support configurable isolation as between initiator sub-modules and functions, applications, tasks, and so on. This highly granular approach may be useful for isolation in the case of mixed criticality as between different applications and within applications. Access control enforcement circuitry 260 associated with a transaction target 270 receives a transaction with an appended TID and, based on the target access configuration, allows execution of transactions that seek a permitted type of access or blocks execution of transactions that seek an unpermitted type of access to the transaction target.

In one example, the target access configuration 265 includes a TAR set, each register mapping a TID a type of access to the target. Based on the TAR register content and the transaction opcode (defining a type of requested access), the access control enforcement circuitry 260 screens (e.g., allows or disallows) the transaction. Respective access control enforcement circuitries 260 may be associated with respective transaction targets or groups of targets 270 and implemented within the transaction target 270, within the interconnect 250, or in components external to both the transaction target and the interconnect 250.

While in the illustrated example, the root of trust circuitry 230 generates the initiator access configurations by mapping TIDs to types of target access, in other examples, other entities may be responsible for assigning TIDs to applications and functions. In this case the root of trust circuitry 230 generates the target access configurations to assign a level of target access to each TID in a secure manner. Thus, the root of trust access configuration 285 may include target access configurations 265 for the transaction targets without including initiator access configurations 225. In other examples, the root of trust access configuration 285 also includes the initiator access configurations 225).

Recall that the root of trust circuitry 230 may not belong to a lowest power domain due to its power consumption. When the microcontroller exits the low power mode, the root of trust circuitry 230 must be powered up and used to generate the initiator access configurations 225 and target access configurations 265 because there is uncertainty as to whether the configurations changed due to error or tampering when the microcontroller was in low power mode. This powering up of the microcontroller to enable enforcement of the isolation scheme delays the time at which the microcontroller may begin executing transactions. Further, the root of trust circuitry 230 must be included in any power domain that includes even a limited number of components that may generate or execute transactions that include TIDs, which increases power consumption.

Disclosed herein are solutions that allow enforcement of a TID based isolation scheme even in low power mode by implementing the enforcement aspect of the isolation scheme in secured isolation circuitry that belongs to a lower power mode than the root of trust circuitry that implements the configuration aspect of the isolation scheme.

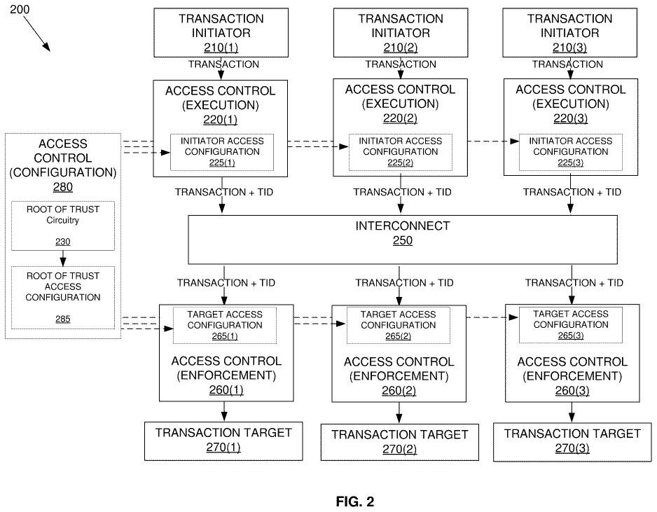

FIG. 3 is a block diagram illustrating an example microcontroller 300 that includes the similar elements as those described with reference to FIG. 2 as reflected by reference characters having the same tens and ones digits. The microcontroller 300 performs the TID-based access control configuration as described above with root of trust circuitry 330 generating and storing a root of trust access configuration 385 that includes at least target access configurations 365. The microcontroller 300 includes secured isolation circuitry 390 that may be in a lower power domain than the root of trust circuitry 330.

To extend enforcement of the isolation scheme into power domains lower than the power domain of the root of trust circuitry 330, after generating the root of trust access configurations 385 the access control configuration circuitry 380 provides secured access configuration information 395 to secured isolation circuitry 390. The secured access configuration information 395 is based on the root of trust access configuration 385. For example, the secured access configuration information may be a reference value that the access control configuration circuitry 380 computes based on a reference function performed on the target access configurations. When the target access configurations are stored in TAR sets, the reference function may be performed on the values of the bits stored in the TAR sets. The reference function may be, for example, a hash function. A different reference value may be computed for each of the target access configurations associated with different transaction targets. Alternatively or additionally, the secured access configuration information may include an image of the target access configuration(s). The image may provide sufficient information for the secured isolation circuitry 390 to restore a target access configuration 365 as will be discussed below.

After the root of trust circuitry 330 has generated the root of trust access configuration 385 and provided the secured access configuration information to the secured isolation circuitry 390, the microcontroller may enter a lower power mode in which the root of trust circuitry 330 may be placed in an OFF or standby mode in which the root of trust circuitry 330 is incapable of generating or enforcing the target access configurations 365.

While the microcontroller 300 is in the low power mode, the secured isolation circuitry 390 is powered on and capable of enforcing the isolation scheme as follows. The secured isolation circuitry 390 periodically or in response to a trigger condition reads a target access configuration 365 and verifies it based on the secured access configuration information. For example, if the secured access configuration information 395 includes a reference value (e.g., hash value) computed based on a reference function with the root of trust access configuration 385 as the input, the secured isolation circuitry 390 may perform the reference function on the current target access configuration 365 and compare the resulting value with the reference value. If the values match, it can be determined that the target access configuration 365 is verified and that the isolation scheme remains in effect. In this manner, even while the microcontroller is in low power mode and the root of trust circuitry 330 is not capable of enforcing the target access configurations 365, the secured isolation circuitry may confirm that the target access configurations 365 remain in accordance with the configuration performed by the root of trust circuitry.

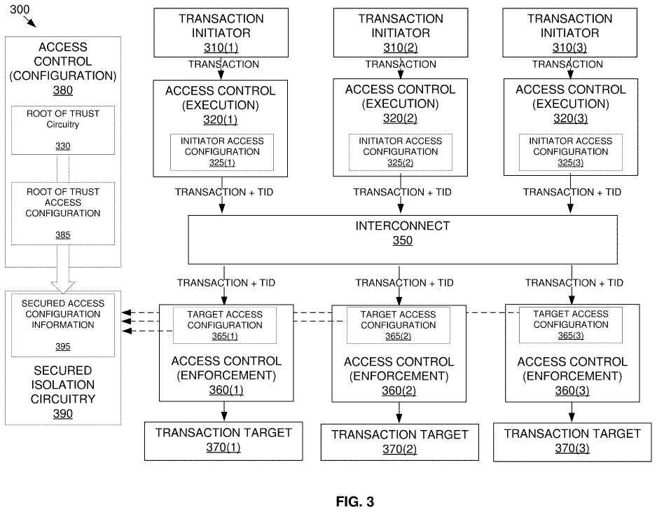

FIG. 4 is a block diagram illustrating example secured isolation circuitry 490. The secured isolation circuitry 490 includes a processor (not shown) that belongs to the low power domain and secure memory 495 configured to store secured access configuration information. The secure memory 495 may be located in the root of trust circuitry (e.g., behind the firewall) and/or include hardware or firmware-based access protections that permit writing only by the root of trust circuitry. In the illustrated example, the memory 495 is configured to store a reference value 496 and, optionally, a reference function that was used by the root of trust circuitry to generate the reference value.

The secured isolation circuitry 490 verifies the target access configuration 365 as follows. The secured isolation circuitry monitors for one or more verification triggers. A verification trigger may be, for example, expiration of a timer that sets a regular period for the verification operation. A verification trigger may be an occurrence of a trigger event such as the microcontroller transitioning to a lower power domain or to a higher power domain. In this manner the target access configuration 365 may be verified before a transaction is provided to the access control enforcement circuitry 360 upon the microcontroller entering a higher power domain. The verification trigger may be provided by an external component that detects a potential error or fault condition related to the isolation scheme.

In response to a verification trigger, the secured isolation circuitry 490 reads the target access configuration 365 and, at 492, computes a reference value based on the target access configuration. The reference function may be a hash function or any other function that produces a result based on the content of the target access configuration (e.g., TAR set contents or bits). The reference function may be preconfigured and/or stored in the memory 495. At 494 the secured isolation circuitry 490 compares the computed reference value to the stored reference value 496. Recall that the stored reference value was received from the root of trust circuitry and is based on the root of trust access configuration. When the computed reference value matches the stored reference value 496 the microcontroller may be assumed to be operating in accordance with the isolation scheme/TID-based access control as configured by the root of trust circuitry.

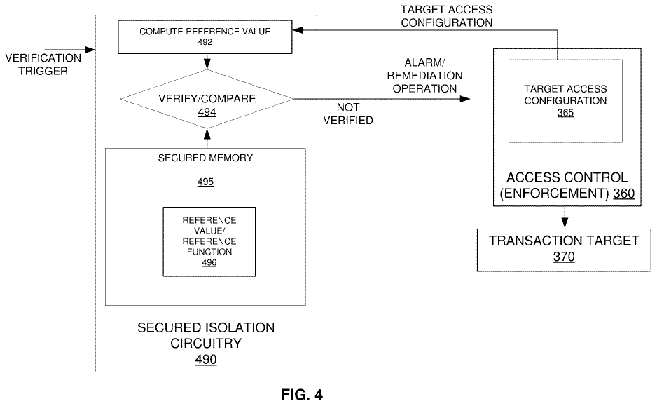

When the computed reference value does not match the stored reference value 496, the secured isolation circuitry 490 generates an alarm signal and/or perform other remediation operations. Remediation operations may include generating one or more interrupts, providing a reset command to the microcontroller, and/or, as will be described in more detail with reference to FIG. 5, restoring the target access configuration.

FIG. 5 is a block diagram illustrating example secured isolation circuitry 590. The secured isolation circuitry includes a processor (not shown) that belongs to a lower power domain than root of trust circuitry. Secured isolation circuitry 590 also includes secure memory 595 configured to store secured access configuration information. The secure memory 595 may be located in the root of trust circuitry (e.g., behind the firewall) and/or include hardware or firmware-based access protections that permit writing only by the root of trust circuitry. In the illustrated example, the memory 595 is configured to store an image 597 of the root of trust access configuration generated by the root of trust circuitry during configuration of the access control mechanism. The image may provide sufficient information for the secured isolation circuitry 590 to restore the target access configuration 365 (e.g., set the bit values in the TAR set). In some examples, the memory 595 may store more than one target access configuration images 597. The multiple images may correspond to different target access configurations associated with different transaction targets. The multiple image may include different images for the same target access configuration 365 corresponding to different quality of service (QoS) levels.

The secured isolation circuitry 590 monitors for one or more restoration triggers. A restoration trigger may be, for example, expiration of a timer that sets a regular period for the verification operation. A restoration trigger may be an occurrence of a trigger event such as the microcontroller transitioning to a lower power domain or a higher power domain. In this manner the target access configuration 365 may be restored before a transaction is provided to the access control enforcement circuitry 360 upon the microcontroller entering a higher power domain. The restoration trigger may be provided by an external component that detects a potential error or fault condition related to the isolation scheme. The restoration trigger may be an indication that the quality of service (QoS) provided by the microcontroller has changed. In response to this trigger, the secured isolation circuitry 590 may select a target access configuration image 597 associated with the new QoS. The restoration trigger may correspond to a remediation operation that is triggered by a failed verification of a target access configuration as outlined in FIG. 4.

In response to a restoration trigger, the secured isolation circuitry 590 restores the target access configuration 365 based on a selected target access configuration image. This may be performed by, for example, setting bits in a TAR set to correspond to bit values in the image. In this manner, the microcontroller is able to commence operation in accordance with the isolation scheme configured by the root of trust circuitry without intervention by the root of trust circuitry.

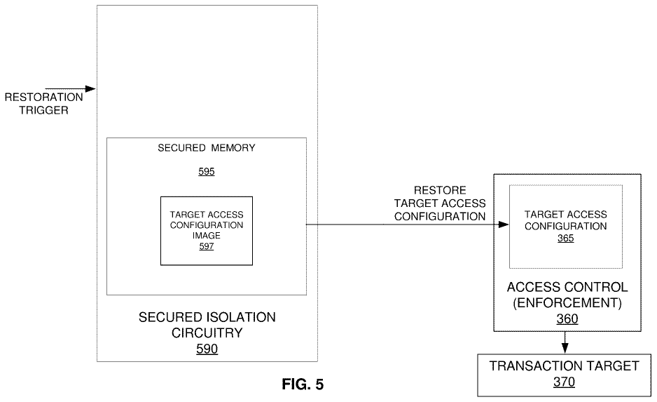

FIG. 6 is a flow diagram outlining an example method 600 that may be performed by secured isolation circuitry, such as for example, the secured isolation circuitry 390, 490, or 590 of FIGS. 3, 4, and 5, respectively. Performance of the method 600 may be triggered by the occurrence of certain trigger events. The trigger events may include the controller exiting standby power mode or moving between power modes, a change in a QoS provided by the controller, expiration of a certain period of time, and so on.

The method 600 includes, at 610, verifying a target access configuration (see, e.g., target access configuration 365 of FIG. 3) based on secured access configuration information. The target access configuration is associated with a target device such, as for example, a peripheral or protected memory. The target access configuration may be, for example, stored in TID assignment registers (TARs) that map TIDs to respective types of access to the target device. The types of access include read or write access. The secured access configuration information may be received from root of trust circuitry, such as circuitries 130, 230, or 330 of FIGS. 1, 2, and 3, respectively.

In one example, the secured access configuration information includes a reference value computed based on a reference function using a root of trust target access configuration as an input. The reference function may be, for example, a hash function that is performed on the content of the TARs. In this example, the target access configuration may be verified by, for example, performing the reference function on the target access configuration (e.g., the contents of the TAR set associated with the target) to generate a computed reference value and comparing the computed reference value to the reference value. When the computed reference value matches the reference value, the target access configuration is considered as being verified and the method ends until triggered again.

The secured access configuration information may alternatively or additionally include an image of the root of trust access configuration. This image may correspond to, represent, or otherwise capture the bit settings in the TAR associated with the target in a manner that allows the image to be used to restore the TAR associated with the target to the root of trust access configuration.

The method includes, at 620, in response to failed verification, performing one or more remediation operations. The remediation operations may include restoring the target access configuration based on the secured access configuration information. For example, when the secured access configuration information includes an image of the root of trust access configuration, the contents of the TARs for the target may be set based on the image. The remediation operations may include transmitting an alarm signal or triggering a controller reset.

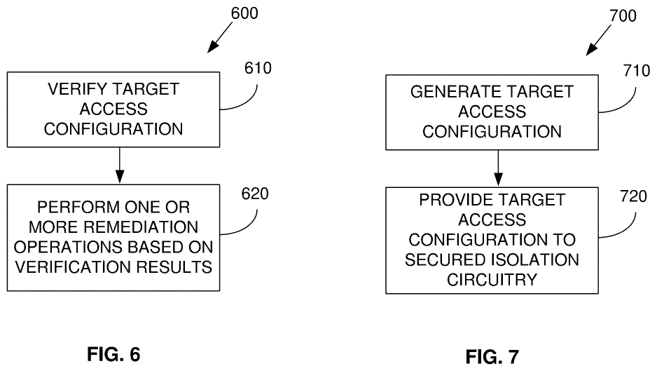

FIG. 7 is a flow diagram outlining an example method 700 that may be performed by root of trust circuitry, such as circuitries 130, 230, or 330 of FIGS. 1, 2, and 3, respectively. The method 700 includes, at 710, generating a target access configuration that maps transaction initiators to a level of access to a target. This target access configuration may be referred to as a root of trust access configuration herein. The access configuration may be generated, for example, as outlined in FIG. 2. The access configuration may include information that is used to set bit values in TARs (e.g., 265 of FIG. 2) associated with the target.

At 720, the method includes providing secured access configuration information to secured isolation circuitry, such as for example, the secured isolation circuitry 390, 490, or 590 of FIGS. 3, 4, and 5, respectively. The secured isolation security operates in a lower power domain than the root of trust circuitry, The secured access configuration information is generated by the root of trust circuitry based on the (root of trust) target access configuration. In some examples, the secured access configuration information includes a reference value calculated based on the target access configuration. In some examples, the secured access configuration information additionally or alternatively includes an image of the target access configuration.

In this description and the appended claims, use of the term “determine” with reference to some entity (e.g., parameter, variable, and so on) in describing a method step or function is to be construed broadly. For example, “determine” is to be construed to encompass, for example, receiving and parsing a communication that encodes the entity or a value of an entity. “Determine” should be construed to encompass accessing and reading memory (e.g., lookup table, register, device memory, remote memory, and so on) that stores the entity or value for the entity. “Determine” should be construed to encompass computing or deriving the entity or value of the entity based on other quantities or entities. “Determine” should be construed to encompass any manner of deducing or identifying an entity or value of the entity.

As used herein, the term identify when used with reference to some entity or value of an entity is to be construed broadly as encompassing any manner of determining the entity or value of the entity. For example, the term identify is to be construed to encompass, for example, receiving and parsing a communication that encodes the entity or a value of the entity. The term identify should be construed to encompass accessing and reading memory (e.g., device queue, lookup table, register, device memory, remote memory, and so on) that stores the entity or value for the entity.

As used herein, the term indicate when used with reference to some entity (e.g., parameter or setting) or value of an entity is to be construed broadly as encompassing any manner of communicating the entity or value of the entity either explicitly or implicitly. For example, bits within a transmitted message may be used to explicitly encode an indicated value or may encode an index or other indicator that is mapped to the indicated value by prior configuration. The absence of a field within a message may implicitly indicate a value of an entity based on prior configuration.

While the invention has been illustrated and described with respect to one or more implementations, alterations and/or modifications may be made to the illustrated examples without departing from the spirit and scope of the appended claims. In particular regard to the various functions performed by the above described components or structures (assemblies, devices, circuits, circuitries, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations of the invention.

Examples can include subject matter such as a method, means for performing acts or blocks of the method, at least one machine-readable medium including instructions that, when performed by a machine cause the machine to perform operations according to embodiments and examples described herein.

### Examples

Example 1 is a controller, including a transaction target; access control enforcement circuitry; root of trust access control configuration circuitry; and secured isolation circuitry. The access control enforcement circuitry is configured to screen, based on a target access configuration, transactions that request access to the transaction target. The root of trust access control configuration circuitry is coupled to the transaction target and is configured to generate a root of trust target access control configuration for the transaction target, wherein the root of trust target access control configuration maps transaction initiators to levels of access to the transaction target; and provide the target access control configuration to the access control enforcement circuitry, wherein the target access control configuration is based on the root of trust target access control configuration. The secured isolation circuitry includes a memory to store secured access configuration information, wherein the secured access configuration information is based on the root of trust target access control configuration and a processor. The processor is configured to receive the secured access configuration information from the root of trust access control configuration circuitry; verify the target access configuration based on the secured access configuration information; and in response to a failed verification of the target access configuration, perform one or more remediation operations.

Example 2 includes the subject matter of example 1, including or omitting optional elements, wherein the secured isolation circuitry is in a lower power domain than the access control enforcement circuitry.

Example 3 includes the subject matter of example 1, including or omitting optional elements, wherein the secured isolation circuitry is in a lower power domain than the root of trust access control configuration circuitry.

Example 4 includes the subject matter of example 1, including or omitting optional elements, wherein the secured access configuration information includes a reference value calculated based on a reference function and the root of trust target access configuration; and the secured isolation circuitry is configured to perform the reference function on the target access configuration to generate a computed reference value; and compare the computed reference value to the reference value to verify the target access configuration.

Example 5 includes the subject matter of example 1, including or omitting optional elements, wherein the secured access configuration information includes an image of the target access configuration.

Example 6 includes the subject matter of example 1, including or omitting optional elements, wherein the secured isolation circuitry is configured to verify the target access configuration in response to the controller entering a different power mode.

Example 7 includes the subject matter of example 1, including or omitting optional elements, wherein the secured isolation circuitry is configured to restore the target access configuration based on the secured access configuration information in response to a restoration trigger.

Example 8 includes the subject matter of example 7, including or omitting optional elements, wherein the restoration trigger includes the controller entering a different power mode.

Example 9 includes the subject matter of example 7, including or omitting optional elements, wherein the restoration trigger includes the target access configuration not corresponding to a current quality of service (QoS) access control configuration.

Example 10 includes the subject matter of example 1, including or omitting optional elements, wherein the one or more remediation operations include transmitting an alarm signal, triggering a controller reset, or restoring the target access configuration.

Example 11 is secured isolation circuitry, including a memory, configured to store secured access configuration information; and a processor, configured to verify a target access configuration associated with a transaction target based on the secured access configuration information and, in response to failed verification, perform one or more remediation operations.

Example 12 includes the subject matter of example 11, including or omitting optional elements, wherein the processor is configured to receive the secured access configuration information from a root of trust circuitry.

Example 13 includes the subject matter of example 12, including or omitting optional elements, wherein the processor is configured to perform a reference function on the target access configuration to generate a computed reference value and wherein the secured access configuration information includes a reference value computed based on a root of trust target access configuration.

Example 14 includes the subject matter of example 11, including or omitting optional elements, wherein the secured access configuration information includes an image of a root of trust access configuration.

Example 15 includes the subject matter of example 11, including or omitting optional elements, wherein the processor is configured to verify the target access configuration in response to a controller changing power modes.

Example 16 includes the subject matter of example 11, including or omitting optional elements, wherein the one or more remediation operations include restoring the target access configuration based on the secured access configuration information.

Example 17 includes the subject matter of example 11, including or omitting optional elements, wherein the one or more remediation operations include transmitting an alarm signal or trigger a controller reset.

Example 18 is root of trust circuitry, including a processor coupled to a memory and configured to, when executing instructions stored in the memory, generate a target access configuration that maps transaction initiators to a level of access to a target; and provide secured access configuration information to secured isolation circuitry that operates in a lower power domain than the root of trust circuitry, the secured access configuration information generated based on the target access configuration.

Example 19 includes the subject matter of example 18, including or omitting optional elements, wherein the secured access configuration information includes a reference value calculated based on the target access configuration.

Example 20 includes the subject matter of example 18, including or omitting optional elements, wherein the secured access configuration information includes an image of the target access configuration.

Various illustrative logics, logical blocks, modules, circuitries, and circuits described in connection with aspects disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform functions described herein. A general-purpose processor can be a microprocessor, but, in the alternative, processor can be any conventional processor, controller, microcontroller, or state machine.

In the present disclosure like reference numerals are used to refer to like elements throughout, and wherein the illustrated structures and devices are not necessarily drawn to scale. As utilized herein, terms “module”, “component,” “system,” “circuit,” “circuitry,” “element,” “slice,” and the like are intended to refer to a computer-related entity, hardware, software (e.g., in execution), and/or firmware. For example, circuitry or a similar term can be a processor, a process running on a processor, a controller, an object, an executable program, a storage device, and/or a computer with a processing device. By way of illustration, an application running on a server and the server can also be circuitry. One or more circuitries can reside within a process, and circuitry can be localized on one computer and/or distributed between two or more computers. A set of elements or a set of other circuitry can be described herein, in which the term “set” can be interpreted as “one or more.”

As another example, circuitry or similar term can be an apparatus with specific functionality provided by mechanical parts operated by electric or electronic circuitry, in which the electric or electronic circuitry can be operated by a software application or a firmware application executed by one or more processors. The one or more processors can be internal or external to the apparatus and can execute at least a part of the software or firmware application. As yet another example, circuitry can be an apparatus that provides specific functionality through electronic components without mechanical parts; the electronic components can include field gates, logical components, hardware encoded logic, register transfer logic, one or more processors therein to execute software and/or firmware that confer(s), at least in part, the functionality of the electronic components.

Use of the word exemplary is intended to present concepts in a concrete fashion. The terminology used herein is for the purpose of describing particular examples only and is not intended to be limiting of examples. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof. As used herein the term “or” includes the option of all elements related by the word or. For example A or B is to be construed as include only A, only B, and both A and B. Further the phrase “one or more of” followed by A, B, or C is to be construed as including A, B, C, AB, AC, BC, and ABC.

What is claimed is:

1. A controller, comprising:
a transaction target;
access control enforcement circuitry configured to screen, based on a target access configuration, transactions that request access to the transaction target;
root of trust access control configuration circuitry coupled to the transaction target, the root of trust access control configuration circuitry configured to
generate a root of trust target access control configuration for the transaction target, wherein the root of trust target access control configuration maps transaction initiators to levels of access to the transaction target; and
provide the target access control configuration to the access control enforcement circuitry, wherein the target access control configuration is based on the root of trust target access control configuration; and
secured isolation circuitry comprising
a memory to store secured access configuration information, wherein the secured access configuration information is based on the root of trust target access control configuration; and
a processor configured to
receive the secured access configuration information from the root of trust access control configuration circuitry;
verify the target access configuration based on the secured access configuration information; and
in response to a failed verification of the target access configuration, perform one or more remediation operations.

2. The controller of claim 1, wherein the secured isolation circuitry is in a lower power domain than the access control enforcement circuitry.

3. The controller of claim 1, wherein the secured isolation circuitry is in a lower power domain than the root of trust access control configuration circuitry.

4. The controller of claim 1, wherein
the secured access configuration information includes a reference value calculated based on a reference function and the root of trust target access configuration; and
the secured isolation circuitry is configured to
perform the reference function on the target access configuration to generate a computed reference value; and
compare the computed reference value to the reference value to verify the target access configuration.

5. The controller of claim 1, wherein the secured access configuration information includes an image of the target access configuration.

6. The controller of claim 1, wherein the secured isolation circuitry is configured to verify the target access configuration in response to the controller entering a different power mode.

7. The controller of claim 1, wherein the secured isolation circuitry is configured to restore the target access configuration based on the secured access configuration information in response to a restoration trigger.

8. The controller of claim 7, wherein the restoration trigger comprises the controller entering a different power mode.

9. The controller of claim 7, wherein the restoration trigger comprises the target access configuration not corresponding to a current quality of service (QoS) access control configuration.

10. The controller of claim 1, wherein the one or more remediation operations include transmitting an alarm signal, triggering a controller reset, or restoring the target access configuration.

11. Secured isolation circuitry, comprising:
a memory, configured to store secured access configuration information; and
a processor, configured to verify a target access configuration associated with a transaction target based on the secured access configuration information and, in response to failed verification, perform one or more remediation operations.

12. The secured isolation circuitry of claim 11, wherein the processor is configured to receive the secured access configuration information from a root of trust circuitry.

13. The secured isolation circuitry of claim 12, wherein the processor is configured to perform a reference function on the target access configuration to generate a computed reference value and wherein the secured access configuration information includes a reference value computed based on a root of trust target access configuration.

14. The secured isolation circuitry of claim 11, wherein the secured access configuration information includes an image of a root of trust access configuration.

15. The secured isolation circuitry of claim 11, wherein the processor is configured to verify the target access configuration in response to a controller changing power modes.

16. The secured isolation circuitry of claim 11, wherein the one or more remediation operations include restoring the target access configuration based on the secured access configuration information.

17. The secured isolation circuitry of claim 11, wherein the one or more remediation operations include transmitting an alarm signal or trigger a controller reset.

18. Root of trust circuitry, comprising a processor coupled to a memory and configured to, when executing instructions stored in the memory,
generate a target access configuration that maps transaction initiators to a level of access to a target; and
provide secured access configuration information to secured isolation circuitry that operates in a lower power domain than the root of trust circuitry, the secured access configuration information generated based on the target access configuration.

19. The root of trust circuitry of claim 18, wherein the secured access configuration information includes a reference value calculated based on the target access configuration.

20. The root of trust circuitry of claim 18, wherein the secured access configuration information includes an image of the target access configuration.
